(19) United States
(12) Patent Application Publication
(10) Pub. No.: US 2012/0052158 A1
(43) Pub. Date: Mar. 1, 2012

(54) BEVERAGE MIXER FORMULATION

(75) Inventors: Jason A. Hardi, Raleigh, NC (US); Marc Adam Greenspoon, Chicago, IL (US)

(73) Assignee: BUTABI BROTHERS, LLC, Fern Park, FL (US)

(21) Appl. No.: 12/870,631

(22) Filed: Aug. 27, 2010

(51) Int. Cl. C12G 3/00; A23L 1/302

(52) U.S. Cl. 426/72; 426/592

(57) ABSTRACT

Formulations for producing alcohol-containing beverages may be provided in single serving packages and combined with liquid at a point of use. An exemplary beverage mixer includes a flavoring agent, L-glutamine, ginger root, and at least two of the following items (i) to (v): (i) thiamine; (ii) pantothenic acid; (iii) pyridoxine, pyridoxal, or pyridoxamine; (iv) cobalmin; and (v) folic acid. Particulate-based and tablet-based solid forms and liquid forms are disclosed.

### FIELD OF THE INVENTION

The present invention relates to formulations for producing drinkable beverages, delivery of such formulations, and beverages including such formulations.

### DESCRIPTION OF THE RELATED ART

Owing to demand for variety in alcoholic beverages, a large number of different beverages have been produced, including fermented beverages (e.g., beer, wine, sparkling wine, etc.) and distilled spirits of various types. Mixed drinks commonly include distilled spirits and one or more conventional liquid mixers that are combined just prior to consumption by the user.

Liquid mixers for alcoholic beverages have been adopted on a nearly universal basis due to their easy combinability with distilled spirits. Mixed drinks can be made using liquid drink mixers with high speed and minimal effort. Drawbacks associated with liquid mixers include high transport costs, large volumetric storage requirements, and limited shelf life (with attendant spoilage issues). Additionally, liquid drink mixers often contain substantial amounts of sugar, thereby increasing caloric content of mixed drinks and contributing to weight gain by consumers of alcoholic mixed drinks.

Powdered drink mixes are well known for making non-alcoholic flavored beverages and sports drinks. Powdered drink mixes are typically combined with water, juice, or (e.g., in the case of certain protein supplements) milk. Drawbacks associated with powdered drink mixes include: (a) limited solubility in various liquids, such that significant time and effort may be required to achieve desired beverage uniformity (if such uniformity can be attained at all), and (b) reduced convenience in rapidly dispensing measured quantities of mixer (in comparison to use of liquid mixers). Powdered drink mixes have not been widely adopted for use with alcoholic beverages, due to the foregoing drawbacks.

Despite their popularity, alcoholic beverages are also recognized to have deleterious effects on users. Alcohol consumption can contribute to negative health effects including, but not limited to, undesirable blood sugar variation (particularly if consumed by diabetics), weight gain, vitamin depletion, nausea/upset stomach, fatigue, and impaired liver function of users.

It would be desirable to overcome deficiencies associated with conventional additives to alcoholic beverages, and to mitigate deleterious effects associated with alcoholic beverage consumption.

### SUMMARY OF THE INVENTION

The present invention relates in various aspects to formulations for producing drinkable beverages, with such formulations being arranged for addition to a suitable liquid such as an alcoholic beverage. Aspects further include delivery of such formulations, and beverages including these formulations

In one aspect, the invention relates to a beverage mixer arranged for mixing with an alcoholic beverage, the beverage mixer comprising: (A) a flavoring agent; (B) L-glutamine; (C) ginger root; and (D) at least two of the following items (i) to (v): (i) thiamine; (ii) pantothenic acid; (iii) pyridoxine, pyridoxal, or pyridoxamine; (iv) cobalmin; and (v) folic acid.

In another aspect, the invention relates to a powdered solid form beverage mixer arranged in a single serving package, the solid form beverage mixer comprising: (A) a flavoring agent; (B) at least about 25 mg of L-glutamine; (C) at least about 25 mg of ginger root or ginger root extract; (D) at least about 0.7 mg of thiamine; (E) at least about 2 mg of pantothenic acid; (F) at least about 1 mg of any of pyridoxine, pyridoxal, and pyridoxamine; (G) at least about 1 microgram of cobalmin; and (H) at least about 200 micrograms of folic acid.

In a further aspect, the foregoing aspects may be combined with any one or more additional elements or other features as disclosed herein for additional advantage.

Other aspects, features and embodiments of the invention will be more fully apparent from the ensuing disclosure and appended claims.

### BRIEF DESCRIPTION OF THE DRAWINGS

FIG. 1A is a perspective view of a solid particulate form beverage mixer being added to an elongated tubular single serving package according to one embodiment of the present invention.

FIG. 1B is a perspective view of the package containing solid particulate form beverage mixer of FIG. 1A in a sealed condition.

FIG. 2A is a perspective view of a single serving pouch containing solid particulate form beverage mixer according to one embodiment of the present invention.

FIG. 2B is a perspective view of the pouch of FIG. 2A following formation of an opening therein to dispense the solid particulate form beverage mixer.

FIG. 3 is a perspective view of a glass containing a straw (or stirrer) and a beverage including a beverage mixer according to one embodiment of the present invention.

FIG. 4A is a perspective view of a single serving beverage drink mixer in the form of an effervescent tablet according to one embodiment of the present invention.

FIG. 4B is a perspective view of the tablet of FIG. 4A in the process of dissolving within a liquid beverage contained within a glass.

### DETAILED DESCRIPTION OF THE INVENTION, AND PREFERRED EMBODIMENTS THEREOF

The present invention relates to beverage mixer formulations arranged to overcome one or more of the above-described limitations.

In various embodiments, beverage mixers are arranged for addition to alcoholic beverages, are effective to mitigate or reduce deleterious effects of alcohol consumption by users.

It has been theorized that depletion of B-vitamins contributes to low energy levels and general malaise associated with ‘hangover’ following excess alcohol consumption. In order to mitigate or reduce such condition, a beverage mixer according to one embodiment includes at least two, more preferably three, more preferably four, and more preferably all five of the following B-vitamins: (i) thiamine (vitamin B-1); (ii) pantothenic acid (vitamin B-5); (iii) pyridoxine, pyridoxal, or pyridoxamine (three major forms of vitamin B-6); (iv) cobalmin (vitamin B-12); and (v) folic acid or folate (vitamin B-9). Recommended daily values (DV) for the foregoing B-vitamins for adults may include the following:

| | Recommended daily | |
|---|---|---|
| Component | value (DV) for adults | |
| Thiamine | 1.4 | mg |
| Pantothenic acid | 4-7 | mg |
| Pyroxidine, pyroxidal, or pyridoxamine | 2 | mg |
| Cobalmin | 2-3 | μg |
| Folic acid | 400 | μg |

A single serving of a beverage mixer according to one embodiment includes at least about 10% of the recommended daily value, more preferably at least about 50% DV, more preferably at least about 50% DV, more preferably at least about 60% DV, and more preferably at least about 75% DV of at least two, more preferably at least three, more preferably at least four, and still more preferably all five of the foregoing B-vitamins. Such constituent may be present in any amount effective to mitigate or reduce fatigue, headache, and/or low energy conditions associated with excess alcohol consumption.

To mitigate or reduce nausea associated with alcohol consumption, a beverage mixer according to certain embodiments includes at least one of (more preferably both of) (a) L-glutamine and (b) ginger root and/or ginger root extract. Such constituent(s) may be present in any amount effective to mitigate or reduce nausea or upset stomach associated with alcohol consumption. In one embodiment, a single serving of a beverage mixer according to one embodiment includes at least about 25 mg of L-glutamine and at least about 25 mg of ginger root and/or ginger root extract. In one embodiment, at least about 50 mg, or at least about 100 mg, or at least about 150 mg, of any of L-glutamine and ginger root or ginger root extract may be provided in a single serving of a beverage mixer.

Beverage mixers according to preferred embodiments include at least one flavoring agent. Flavoring agents of any desirable type and in any desirable quantity may be used, whether alone or in combination. In certain embodiments, flavoring agents comprise any of fruit flavorings and/or fruit extracts, herbs and/or herb extracts, spices and/or spice extracts; flowers and/or flower extracts; milk, cream, sauces, yeasts and/or yeast extracts, and grains and/or grain extracts In certain embodiments, beverage mixers including flavoring agents are arranged for addition to beverages including distilled spirits. In certain embodiments, beverage mixers including flavoring agents are arranged for addition to fermented beverages (e.g., wine, sparkling wine, beer, malt beverages, and the like). Embodiments include beverage mixers as disclosed herein as combined with fermented alcoholic beverages, and beverage mixers as disclosed herein as combine with distilled alcoholic beverages. In one embodiment, a beverage mixer as disclosed herein may be combined with water or another suitable liquid following ingestion of alcoholic beverages to mitigate or reduce deleterious effects of alcohol consumption.

In one embodiment, a beverage mixer arranged for mixing with an alcoholic beverage, the beverage mixer comprising: (A) a flavoring agent; (B) L-glutamine; (C) ginger root; and (D) at least two of the following items (i) to (v): (i) thiamine; (ii) pantothenic acid; (iii) pyridoxine, pyridoxal, or pyridoxamine; (iv) cobalmin; and (v) folic acid.

Beverage mixers according to preferred embodiments include at least one coloring agent arranged to impart a desired color on the resulting beverage. Optionally at least one clouding agent may be added.

Beverage mixers according to certain embodiments may include one or more stimulants such as caffeine, such as may be provided in pure chemical form and/or green tea products including green tea powder and green tea extract. Stimulants may be provided in any amount effective to reduce fatigue or reduced energy level associated with alcohol consumption. In one embodiment, a single serving beverage mixer includes caffeine in an amount of at least about 40 mg, at least about 50 mg, at least about 60 mg, at least about 80 mg, at least about 100 mg. at least about 150 mg, or at least about 200 mg. Green tea products also include beneficial antioxidants that are believed to enhance cellular function and/or reduce cell aging.

Beverage mixers according to certain embodiments may include taurine (2-aminoethanesulfonic acid), which is necessary for normal skeletal muscle functioning, is understood to reduce liver disease or cirrhosis, produce anxiolytic effect, and act as an anti-anxiety agent in the central nervous system. Taurine may be provided in any suitable amount, including an amount effective to mitigate fatigue and/or enhance liver function. In one embodiment, a single serving beverage mixer includes taurine in an amount of at least about 200 mg, at least about 400 mg, at least about 600 mg, at least about 1000 mg, at least about 1500 mg. or at least about 2000 mg.

Besides taurine, other liver function promoting agents that may be employed (either singly or together) in beverage mixers according to various embodiments include chitosan, D-glucoronolactone, inositol, and silymarin.

In certain embodiments, beverage mixers are flavored and arranged to replace either single or multiple conventional cocktail mixers as used to make conventional cocktails such as margaritas, mojitos, martinis (e.g., apple martini including flavoring and coloring), cosmopolitans, and the like. In other embodiments, beverage mixers are flavored and arranged to produce nonconventional beverages, such as fruit flavored beers, wines, or sparking lines. Fruit flavors such as strawberry, raspberry, peach, watermelon, lemon, lime, grape, banana, and the like may be used.

In certain embodiments, a beverage mixer as provided herein is devoid of any high-caloric sweeteners. For example, a beverage mixer may be devoid of sucrose, glucose, and fructose. Omission of such sweeteners reduces caloric value of beverages made with beverage mixers as disclosed herein, thereby reducing blood sugar variation associated with flavored beverage consumption and reducing contribution to obesity. As a substitute for high caloric sweeteners, one or more reduced calorie sweeteners may be utilized in beverage mixers according to certain embodiments. Examples of desirable low calorie sweeteners include, but are not limited to, rebaudioside A, aspartame, saccharin, cyclamate, acesulfame, sorbitol, and sucralose.

In certain embodiments, a beverage mixer as disclosed herein is in a solid form. Such solid form beverage mixers may variously be embodied in particulate form, in agglomerated form, in bead form, or in tablet form.

In one embodiment, a solid form beverage mixer is in particulate form and comprises an anti-caking agent intended to inhibit caking and thereby promote rapid dissolution. Such anti-caking agent may comprise at least one of magnesium stearate, aluminum stearate, ammonium stearate, glyceryl monostearate, stearic acid, magnesium carbonate, magnesium oxide, sodium silicate, calcium silicate, magnesium silicate, aluminum sodium silicate, aluminum calcium silicate, and zinc silicate.

A solid form beverage mixer in particulate form may be produced by pulverizing and/or milling solid components, and optionally sifting or straining such components via mesh of one or more sizes to yield a desired range of particle sizes. In one embodiment, a solid form beverage mixer has an average particle size of less than 100 microns, more preferably less than 80 microns, more preferably less than 60 microns, more preferably less than 50 microns, and more preferably less than 40 microns. In one embodiment, particles have a lower size range of at least about 10-15 microns. Production of small particle sizes promotes rapid dissolution, as may be desirable to reduce time and effort in attaining full dissolution of the mixer in a liquid to form a desired beverage.

In one embodiment, a beverage mixer as disclosed herein is embodied in a solid tablet arranged to dissolve in contact with a beverage (e.g., alcoholic beverage). The solid tablet may be effervescent in character and arranged to produce carbon gas (e.g., carbon dioxide) as bubbles when combined with liquid (e.g., in a beverage). In one embodiment, the release of carbon gas from an effervescing tablet occurs over at least about 1 hour.

An effervescent tablet may include a carbonate salt (including bicarbonates) and an acidulating agent, both acceptable for human consumption. Suitable carbonate salts include sodium bicarbonate, calcium bicarbonate, potassium bicarbonate, barium bicarbonate, strontium bicarbonate, and magnesium bicarbonate. Suitable acidulating agents include acid materials preferably having a pKₐ of at least about 2, preferably in a range of from about 2 to about 5, considered safe for human ingestion. Examples of acids constituting suitable acidulating agents include citric acid, ascorbic acid, malic acid, succinic acid, tartaric acid, and phosphoric acid, with citric, tartaric, and malic acids being preferred.

In one embodiment, sodium bicarbonate, citric acid, and tartaric acid are present in an effervescent tablet in one of the following suitable ratios: (a) 2:1:3; (b) 2.5:2:2.5; (c) 2.5:2.5:2; 2:5:2:3; (d) 1:0.05:1; and (3) 1:1:1. In one embodiment, the minimum percentage ratios of sodium bicarbonate, citric acid, and tartaric acid is 0.88%:0.05%:0.88%. Use of acidulating agents (including citric acid, tartaric acid, and others) in combination with carbonate (including bicarbonate) salts in appropriate ratios to mitigate alkaline taste and attain appropriate pH is disclosed by U.S. Pat. No. 3,660,107, which is hereby incorporated by reference herein.

In one embodiment, a solid form beverage mixer arranged to generate a carbon gas further comprises an edible anti-foam agent. In one embodiment, an anti-foam agent may be present in a concentration of about 20 to about 200 ppm by dry weight of the dry beverage mixer. Exemplary edible anti-foam agents include polysiloxanes or organopolysiloxanes of various types that are commercially available.

In one embodiment, an effervescing beverage mixer is arranged for addition to a non-carbonated beverage (e.g., wine or distilled spirits). In another embodiment, an effervescing beverage mixer is arranged for addition to a pre-carbonated beverage such as beer or sparking wine, in order to enhance or prolong the carbonated effect thereof, as well as to affect flavor of the resulting combination.

In certain embodiments, beverage mixers as disclosed herein may be provided in liquid form. Constituents as disclosed herein may be dissolved or suspended in any suitable liquid medium such as water and/or alcohol, or another suitable ingestible liquid.

A liquid form beverage mixer may be disposed in a single serving package. In one embodiment, a liquid form beverage mixer is arranged within a pouch, cup, or elongated tubular package having at least one removably adhered, scored, tearable, rupturable or otherwise weakened portion (e.g., along an end thereof) to facilitate rupture upon user interaction for addition of the liquid to a liquid (e.g., alcohol-containing liquid) to form a beverage. The package may be opaque (e.g., polyethylene coated foil) to prevent degradation of contents in exposure to light. A liquid form beverage mixer package may be in the form of a hollow elongated tubular element with removable ends (and optionally at least one widened end portion), thereby permitting the package to serve as a stirring implement and/or a straw for mixing of a beverage.

Exemplary single serving packages and forms for beverage mixers are disclosed in the figures. Such exemplary packages and forms should not be construed as in any way limiting the scope of the invention, but rather as illustrative of embodiments of the invention in a specific application thereof.

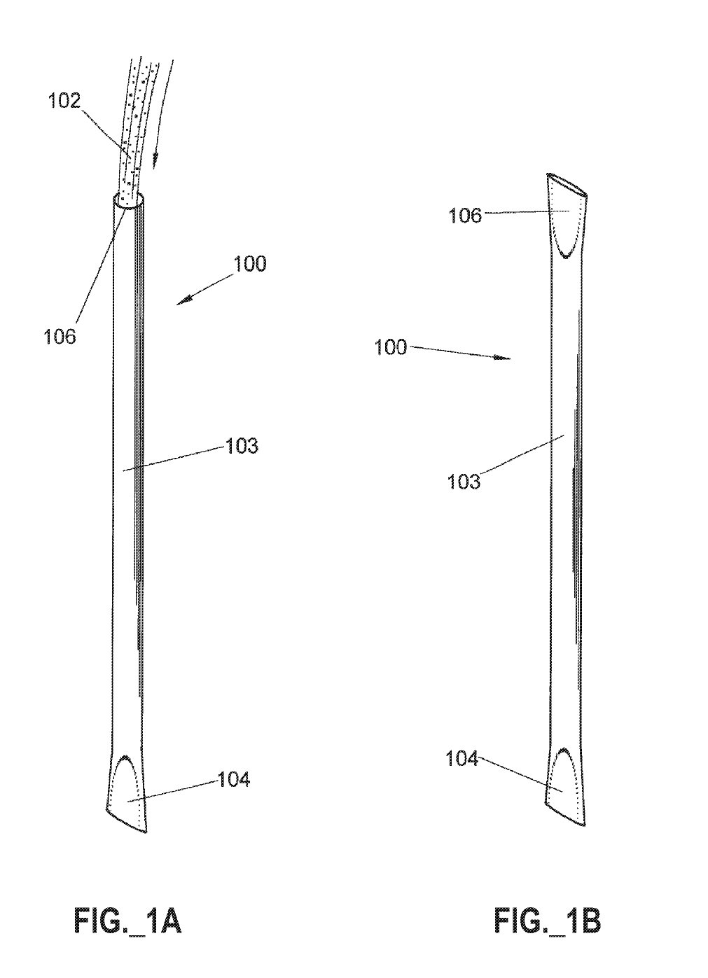

FIG. 1A illustrates a solid particulate form beverage mixer 102 being added to an elongated tubular single serving package 100 according to one embodiment of the present invention. The package 100 includes a tubular body 103, a first end 104, and a second end 106. The ends 104, 106 may be closed by any conventional means, such as heat sealing, ultrasonic welding, adhesives, and the like. The tubular body 103 may be formed of any one or more conventional materials such as extruded plastic, wax covered paper, metal foil, polymer coated foil, or the like. FIG. 1B shows the package 100 containing solid particulate form beverage mixer of FIG. 1A in a sealed condition.

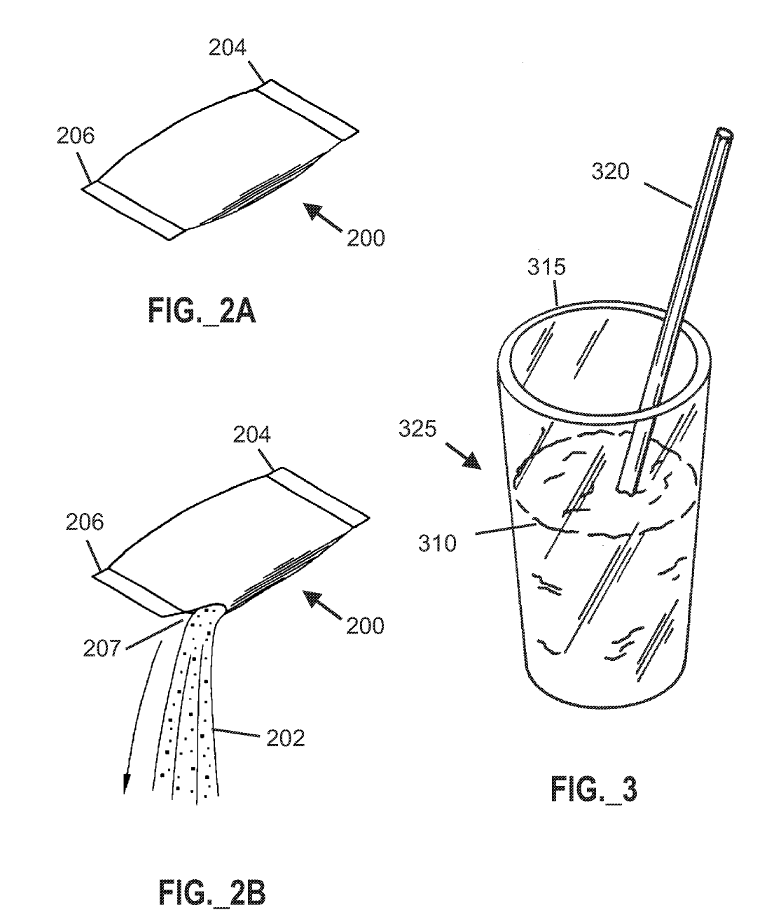

FIGS. 2A-2B illustrate a single serving pouch 200 containing beverage mixer 202 (e.g., of solid particulate form) according to one embodiment of the present invention. The pouch 200 may include a tearable (e.g., pre-scored) portion along a corner thereof to permit a user to create an opening 207 for dispensation of the beverage mixer 202 into an empty glass for addition of liquid or to a beverage already contained in a suitable container.

As illustrated in FIG. 3, a beverage mixer as disclosed herein may be combined with a liquid 310 in a glass 315 (or other container) using a straw 320 or other stirrer to form a beverage 325. Alternatively, mixing between a beverage mixer and a liquid may be promoted by shaking, swishing, agitation, sonication, or other mixing means.

In one embodiment, a powdered solid form beverage mixer arranged in a single serving package, the solid form beverage mixer comprising: (A) a flavoring agent; (B) at least about 25 mg of L-glutamine; (C) at least about 25 mg of ginger root or ginger root extract; (D) at least about 0.7 mg of thiamine; (E) at least about 2 mg of pantothenic acid; (F) at least about 1 mg of any of pyridoxine, pyridoxal, and pyridoxamine; (G) at least about 1 microgram of cobalmin; and (H) at least about 200 micrograms of folic acid.

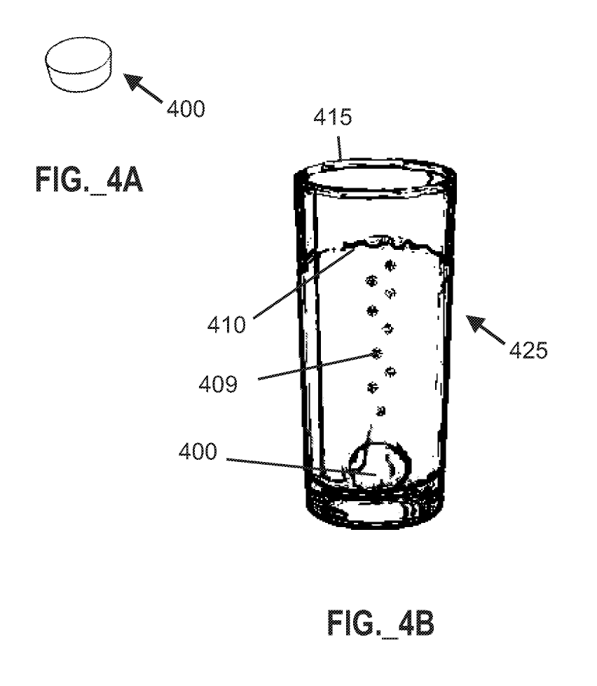

FIG. 4A illustrates a single serving beverage drink mixer in the form of an effervescent tablet 400. Such tablet 400 may be fabricated by milling or pulverizing solid constituents, and then compacting same in a press, optionally aided by a binder and/or soluble coating. FIG. 4B illustrates the tablet 400 of FIG. 4A following addition to a liquid 410 within a glass 415 to release carbon gas 409 and form a beverage 425.

Various shortcomings associated with conventional beverage mixers are overcome by embodiments of the present invention. Specific fomulations disclosed herein mitigate or reduce deleterious effects associated with alcohol consumption. Providing beverage mixers in single serving packages reduces spoilage (and therefore wasted cost) associated with conventional liquid mixers. Beverage mixers in solid form reduce transport costs and volumetric storage requirements. Uniformity in producing beverages is enhanced, and training requirements (for preparation of beverages) may be lessened.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Any one or more features and aspects as disclosed herein may be combined with the other. Correspondingly, the invention as hereinafter claimed is intended to be broadly construed and interpreted, as including all such variations, modifications and alternative embodiments, within its spirit and scope.

What is claimed is:

1. A beverage mixer arranged for mixing with an alcoholic beverage, the beverage mixer comprising:
(A) a flavoring agent;
(B) L-glutamine;
(C) ginger root; and
(D) at least two of the following items (i) to (v):
(i) thiamine;
(ii) pantothenic acid;
(iii) pyridoxine, pyridoxal, or pyridoxamine;
(iv) cobalmin; and
(v) folic acid.

2. The beverage mixer of claim 1, further comprising at least one of rebaudioside A, aspartame, saccharin, cyclamate, acesulfame, sorbitol, and sucralose.

3. The beverage mixer of claim 1, being devoid of sucrose, glucose, and fructose.

4. The beverage mixer of claim 1, further comprising green tea powder or extract.

5. The beverage mixer of claim 1, further comprising caffeine.

6. The beverage mixer of claim 1, comprising at least three of items (i) to (v).

7. The beverage mixer of claim 1, comprising at least four of items (i) to (v).

8. The beverage mixer of claim 1, comprising a liver function promoting agent.

9. The beverage mixer of claim 1, wherein the liver function promoting agent comprises taurine.

10. The beverage mixer of claim 9, wherein the liver function promoting agent comprises at least one of chitosan, D-glucoronolactone, inositol, and silymarin.

11. The beverage mixer of claim 1, in solid form.

12. The beverage mixer of claim 1, in particulate form.

13. The beverage mixer of claim 11, further comprising an anti-caking agent.

14. The beverage mixer of claim 1, comprising a carbonate salt and an acidulating agent, in combination being adapted to generate carbon dioxide when in contact with a liquid.

15. The beverage mixer of claim 14, comprising 20 to 200 ppm of an edible anti-foam agent.

16. The beverage mixer of claim 11, having an average particle size of less than 60 microns.

17. The beverage mixer of claim 1, combined with a fermented alcoholic beverage.

18. The beverage mixer of claim 1, combined with a distilled alcoholic beverage.

19. The beverage mixer of claim 1, in liquid form.

20. The beverage mixer of claim 1, contained in a single serving package, wherein upon opening of the package containing the beverage mixer, the beverage mixer is suitable for combining with a single serving of between about 40 ml and 500 ml of an alcohol-containing liquid to produce a single serving beverage.

21. A method of producing a beverage, comprising adding a drink mixer according to claim 1 to an alcoholic beverage.

22. A powdered solid form beverage mixer arranged in a single serving package, the solid form beverage mixer comprising:
(A) a flavoring agent;
(B) at least about 25 mg of L-glutamine;
(C) at least about 25 mg of ginger root or ginger root extract;
(D) at least about 0.7 mg of thiamine;
(E) at least about 2 mg of pantothenic acid;
(F) at least about 1 mg of any of pyridoxine, pyridoxal, and pyridoxamine;
(G) at least about 1 microgram of cobalmin; and
(H) at least about 200 micrograms of folic acid.

23. The beverage mixer of claim 24, further comprising at least one of rebaudioside A, aspartame, saccharin, cyclamate, acesulfame, sorbitol, and sucralose.
